(19) United States
(12) Patent Application Publication
(10) Pub. No.: US 2024/0419745 A1
(43) Pub. Date: Dec. 19, 2024

(54) PERSONALIZED CONTENT GENERATION

(71) Applicant: INTERNATIONAL BUSINESS MACHINES CORPORATION, ARMONK, NY (US)

(72) Inventors: Alexander Brooks, Denver, CO (US); ChunHui Y. Higgins, Raleigh, NC (US); Gabriel Goodhart, Denver, CO (US); William Patrick Higgins, Durham, NC (US)

(21) Appl. No.: 18/337,210

(22) Filed: Jun. 19, 2023

(51) Int. Cl. G06F 16/9535

(52) U.S. Cl. CPC G06F 16/9535

(57) ABSTRACT

A method, computer system, and a computer program product for personalized content generation. Exemplary embodiments may include receiving content and a desired personality from which to personalize the content, as well as applying the desired personality to the content via application of a personalization model to the content.

### BACKGROUND

The exemplary embodiments relate generally to content generation, and more particularly to personalized content generation.

Artificial intelligence (AI) is commonly used to generate text, audio, images, video, and the like in various settings, such as chatbot conversations, event commentary, etc. While delivering useful information, these AI systems tend to be problematic in some respects. A first problem is that there is no one size fits all AI system. In practice, the AI system is often highly application specific, and specialized with respect to the content types that it processes, such as text, audio, image, etc. Building a good, general AI system remains a challenge and, typically, most applications are better off leveraging a highly specialized model built specifically for the use-case being considered. Second, these AI systems typically don't feel human to a user; the vast majority thereof lack any kind of emotional intelligence. Third, these AI systems are usually not very adaptive; many may have a mechanism for updating their knowledge base, but this is typically something that requires some degree of user involvement, e.g., humans intentionally marking a piece of information as important for a model to consider. These problems make for developing a customized, empathetic AI system that is applicable to any content of a particular content type a formidable challenge.

### SUMMARY

The exemplary embodiments disclose a method, a structure, and a computer system for personalized content generation. The exemplary embodiments may include receiving content and a desired personality from which to personalize the content, as well as applying the desired personality to the content via application of a personalization model to the content.

### BRIEF DESCRIPTION OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts an exemplary block diagram depicting the components of computing environment 100, in accordance with the exemplary embodiments.

FIG. 2 depicts an exemplary flowchart 200 illustrating operations of content personalizer 150 of computing environment 100, in accordance with the exemplary embodiments.

FIG. 3 depicts an exemplary set of texts, in accordance with the exemplary embodiments.

### DETAILED DESCRIPTION

Detailed embodiments of the claimed structures and methods are disclosed herein; however, it can be understood that the disclosed embodiments are merely illustrative of the claimed structures and methods that may be embodied in various forms. The exemplary embodiments are only illustrative and may, however, be embodied in many different forms and should not be construed as limited to the exemplary embodiments set forth herein. Rather, these exemplary embodiments are provided so that this disclosure will be thorough and complete, and will fully convey the scope to be covered by the exemplary embodiments to those skilled in the art. In the description, details of well-known features and techniques may be omitted to avoid unnecessarily obscuring the presented embodiments.

References in the specification to “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of the exemplary embodiments, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements according to the various exemplary embodiments.

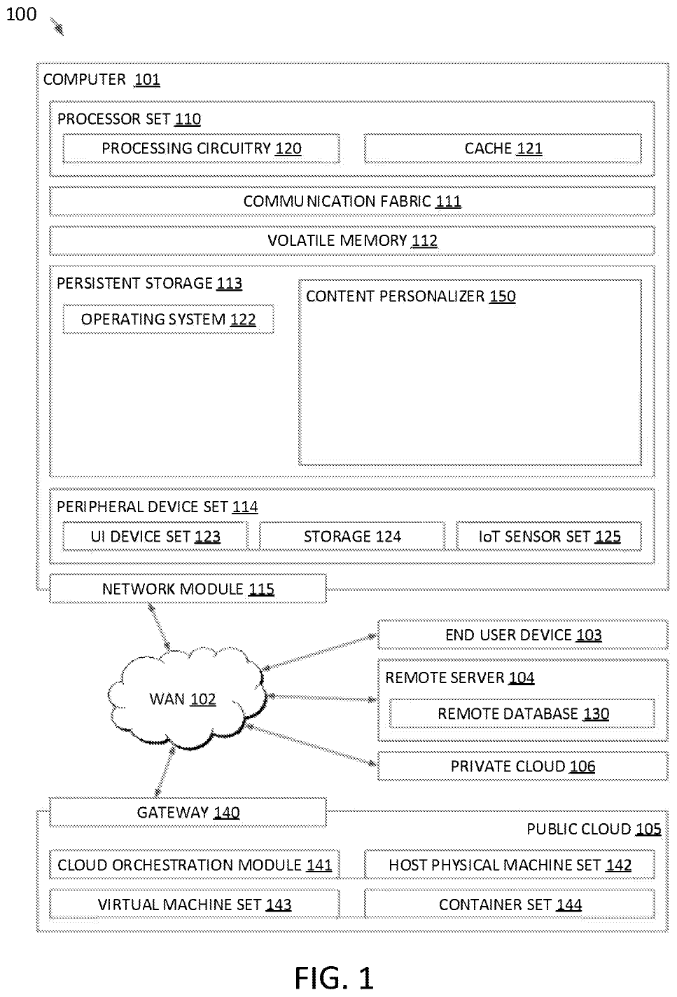

FIG. 1 depicts an exemplary block diagram depicting the components of computing environment 100, in accordance with the exemplary embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as content personalizer 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication Fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open-source Portable Operating System Interface-type operating systems that employ a kernel. The code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user, and may take any of the forms discussed above with respect to computer 101. The EUD 103 may further include any components described with respect to computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

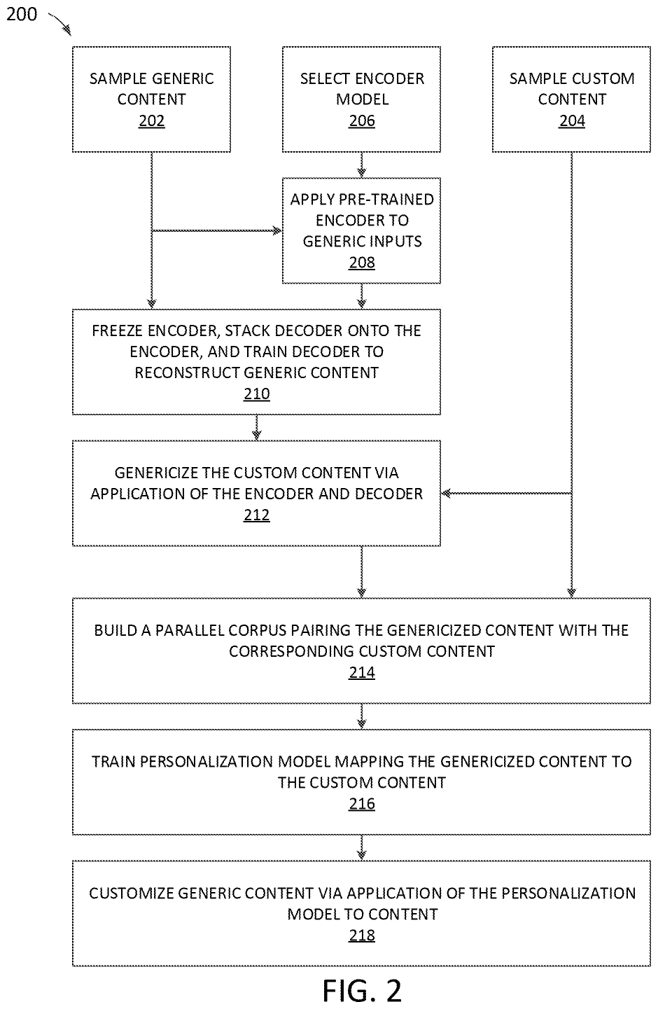

FIG. 2 depicts an exemplary flowchart 200 illustrating the operations of content personalizer 150 of computing environment 100, in accordance with the exemplary embodiments.

Artificial intelligence (AI) is commonly used to generate text, audio, images, video, and the like in various settings, such as chatbot conversations, event commentary, etc. While delivering useful information, these AI systems tend to be problematic in some respects. A first problem is that there is no one size fits all AI system. In practice, the AI system is often highly application specific, and specialized with respect to the content types that it processes, such as text, audio, image, etc. Building a good, general AI system remains a challenge and, typically, most applications are better off leveraging a highly specialized model built specifically for the use-case being considered. Second, these AI systems typically don't feel human to a user; the vast majority thereof lack any kind of emotional intelligence. Third, these AI systems are usually not very adaptive; many may have a mechanism for updating their knowledge base, but this is typically something that requires some degree of user involvement, e.g., humans intentionally marking a piece of information as important for a model to consider. These problems make for developing a customized, empathetic AI system that is applicable to any content of a particular content type a formidable challenge.

The second and third problem are compounding, largely because social cues cannot be easily marked and passed to a model for consideration. To illustrate the way in which these issues are related, consider the following scenario: say you have a chat channel where developers are providing direct user support for a project that they are building and the support burden is no longer manageable. You have two options; hire another developer or build a bot to help with support. Although both come in with limited knowledge, a key difference between the two is that a new developer has emotional intelligence and is sensitive to cultural dynamics. After joining the team, a developer can begin to infer social patterns, e.g., the most effective way to communicate with their teammates and users of the projects and learn to identify the situations in which their input would be most valuable. Further, they can understand how social mechanics change as the project progresses and factor this into how they present their accumulated expertise in the future.

By contrast, a bot may build knowledge that it can share with the rest of the team and users of the project, but it will not typically read the social patterns of the community that it supports or alter its behavior to be more appealing. In some situations, this may be problematic, particularly if the bot is expected to monitor conversations and chime in on its own accord. Being aware of social cues and adaptive to cultural dynamics of a community helps reduce the likelihood of the bot feeling like an invasive entity, which is particularly important for bots that may be deployed to a large number of communities.

Highly customized and personalized AI models will generally have a better report with users than generic stock models, especially if they are embedded into interactive applications. Generative AI models may also be used to create customized content with unique tone, voice, language, and personality, e.g., for event commentary. However, creating such models effectively can be computationally expensive and require access to highly specific datasets, which are not typically available, especially if the model requires a parallel corpus for training. The disclosed system provides a mechanism for personalizing content in a way that is agnostic to the type of content of the content being generated, which can be adapted based on availability of computational resources and data. Depending on the embodiment, it may further customize generated content based on analysis of information such as player/team profiles, past events, social media, or end users' profiles including preferred commenters from the past. It could also personalize inputs by leveraging an end user's profile with social media data analysis or demographic information. In this way, the adaptative mechanism allows for simple hyper-personalization of different types of content, regardless of the content type. In doing so, the present invention provides a clear path to building AI model pipelines that are more human-friendly when it is not feasible to retrain generic models, e.g., when application-specific datasets are not available, or the cost of retraining large stock models is computationally prohibitive for the resources available.

The present invention will now be described with respect to the flowchart depicted by FIG. 2. Overall, the present invention personalizes content by first building a depersonalization model which, when applied to custom content, depersonalizes and genericizes the custom content. The custom content and genericized content may then be used to build a synthetic parallel corpus, which can then be used as training data to build a personalization model. The personalization model can then be applied to any content of a same type (e.g., text, audio, video, image, etc.) to personalize the content as desired. A more detailed description follows.

Content personalizer 150 may sample generic content of some type, for example content of the type text, speech, image, video, etc. (step 202). Though accurate, the generic content may be narrative and lack a style or any personality characteristics. For example, generic text may lack variety in verbiage or syntax, generic images may lack variety in color or design, and generic speech may lack variety in speech pattern, cadence, emphasis, speed, verbiage, and the like. As a result, the generic content may be considered boring and dull to a consumer. In embodiments, content personalizer 150 may sample the generic content from any source of generic content, such as generic text outputs from a model designed to narrate play-by-play of a sporting event.

While the detailed description provided herein describes embodiments of the invention with respect to the content type of text, importantly, no component defined within this system is limited to text, and alternate embodiments may be created to personalize models for different content types, for example, images and speech. Furthermore, embodiments may be composed hierarchically to create more complex systems personalizing multiple aspects of the generic content, for example, taking an uninteresting summary of a sports game and a corresponding audio clip created from generic text to speech software, and both rephrasing the text to be interesting (text embodiment) and personalizing the generative audio to be more dynamic, like a sports announcer (speech embodiment).

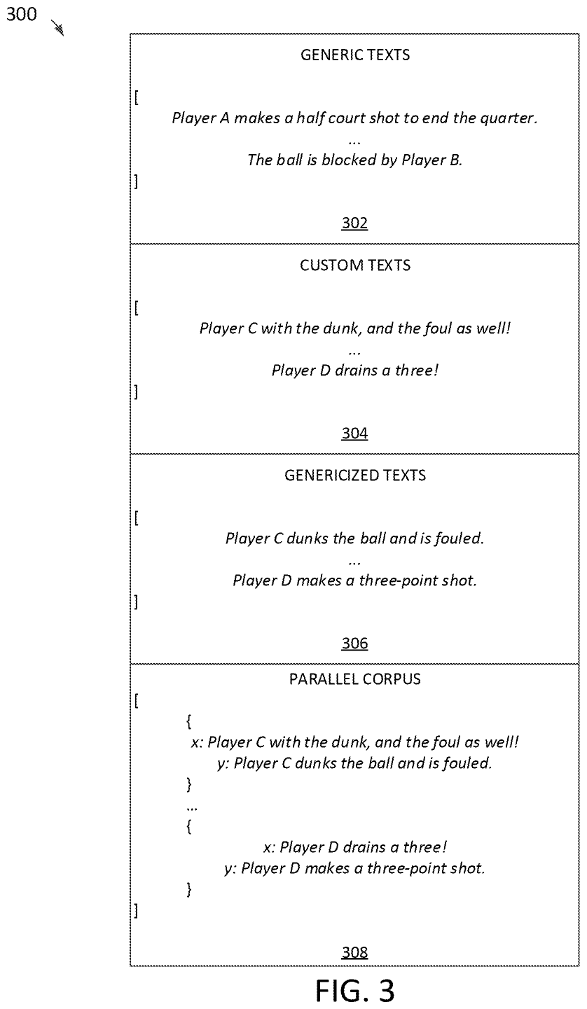

To better illustrate the operations of content personalizer 150, reference is now made to an illustrative, text-based example depicted by FIG. 3 where content personalizer 150 samples generic texts 302 relating to a basketball sporting event.

Content personalizer 150 may sample custom content (step 204). In embodiments, the custom content is of the same content type as the sampled generic content (e.g., text, audio, etc.) and is of a personalized styling that is to be later imitated when ultimately personalizing content. Like the generic content sampled above, the custom content may too be of the type text, speech, images, video, etc., however unlike the generic content, the custom content includes personality. Restated, while remaining accurate, the custom content further includes style and personality characteristics. For example, custom text may include variety in verbiage or syntax, custom images may include variety in color or design, and custom speech may vary in speech pattern, cadence, emphasis, speed, verbiage, and the like. As a result, the custom content may be considered entertaining and engaging to a consumer. In embodiments, content personalizer 150 may sample the custom content from sources of content having personality, for example speech samples from commentators and entertainers or images from artists and photographers. In embodiments, content personalizer 150 may sample custom content from the same or any number of sources and timeframes. For example, content personalizer 150 may sample custom texts from sporting event commentary for different sports played at different times and in different locations. In embodiments, content personalizer 150 may sample custom content from a single source to generate a personalization model that personalizes content specific to that source. In other embodiments, content personalizer 150 may iteratively generate a personalization model for a variety of personalities from a variety of sources, or sample from a variety of sources having similar personality, for example, animated or narrative. Overall, the choice of sampled custom content will ultimately dictate the personalization applied to content.

Furthering the illustrative example introduced above and again with reference to FIG. 3, content personalizer 150 samples custom texts 304 relating to a basketball sporting event.

Referring now back to FIG. 2, content personalizer 150 may select or train an encoder model (step 206). In embodiments, content personalizer 150 may select or train an encoder model that embeds inputs of a content type, e.g., texts, into one or more vectors within a vector space. Importantly, the encoder embeds semantically similar inputs to highly similar vectors. For example, in the case of text, two sentences with different phrasings but the same underlying meaning should be embedded to highly similar vectors. Similarly, in the case of speech, two audio clips of different individuals reciting the same script should be embedded to highly similar vectors. In embodiments personalizing text, content personalizer 150 may utilize any input to vector techniques that satisfy the requirement of maintaining semantic meaning of the inputs for the ingested content type. As such, content personalizer 150 may train or simply select an encoder model having sufficient semantic preservation when embedding into a vector space.

While textual content types may need no further processing for input into an encoder, some content types may benefit from additional processing. Techniques such as normalization, pre-processing, and post-processing may be included within the encoder that benefit the embedding process. For example, in the context of the content type speech, the embeddings should only retain semantic equivalence and therefore features such as average speaking frequency of the speaker and pitch require omission from the embedding. In this case, a calibration may be performed as part of pre-processing the content prior to input into the encoder, such as standardizing the average pitch of speech going into the encoder, or post-processing after being output by the encoder via vector tweaking. By normalizing the content, content personalizer 150 may be more effective in comparing extracted vectors. For example, in speech processing, depending on the vector space chosen, one might normalize the results to achieve better alignment between speakers with similar speaking dynamics at differing frequencies.

Referring to the formerly introduced example for text personalization, content personalizer 150 trains an encoder model that embeds the semantic meaning of a word or sentence into a vector of 512 dimensions.

Content personalizer 150 may apply the encoder to the generic content (step 208). In embodiments, content personalizer 150 may apply the encoder to the generic content to generate representations of the generic content as vectors within the vector space that retain semantic equivalence. In the case of text, for example, content personalizer 150 may embed vectors while, by contrast for speech, content personalizer 150 may embed vectors based on a Mel spectrogram. In some embodiments, pre-processing the input to the encoder or post-processing the raw feature vectors it produces may be helpful in minimizing the impact of characteristics not relevant to the customization type being considered. In such embodiments, any additional pre- or post-processing is also considered part of the encoder module.

Furthering the illustrative example introduced above and illustrated by FIG. 3, content personalizer 150 converts generic texts 302 into 512-dimension vectors that maintain a semantic equivalence to generic texts 302.

Referring back to the flowchart depicted by FIG. 2, content personalizer 150 may freeze the pre-trained encoder and train a decoder to reconstruct generic content (step 210). Once the encoder is deemed sufficiently accurate at converting generic content into semantically identical vectors, content personalizer 150 may stack a trainable decoder onto the frozen encoder that reconstructs the generic content from the vectors embedded within the vector space. In embodiments, content personalizer 150 may train the decoder by comparing the generic content input into the decoder to the genericized output of the decoder, where the goal of the training is to reduce an error rate between the input and the output. The training of the decoder may be considered complete when a loss is less than a threshold, i.e., the decoder reaches a sufficient accuracy. Once trained, the resulting stacked encoder and decoder combination may be referred to as a depersonalization model. The depersonalization model is configured to remove personalization from content, such as removing from speech variety in speech pattern, cadence, emphasis, speed, verbiage, etc. For application to other content types, a similar approach may be used, and the quality of the depersonalization model will be highly dependent on the vector space mapped to by the encoder. In some embodiments, the encoder may not be a trainable model, and may instead be an algorithm or formula with additional optional pre- or post-processing used to map inputs to the appropriate vector space. In such embodiments, it is sufficient to simply train the decoder to map the encoder component's vectors to the corresponding generic inputs they were derived from.

Referring again to the illustrative example formerly introduced, content personalizer 150 trains a decoder to reconstruct genericized text from the vector representations of text. The trained decoder, when combined with the trained encoder, form the depersonalization model that outputs genericized content having a same semantic equivalence as the input.

With reference again to FIG. 2, content personalizer 150 may genericize the custom content via application of the stacked encoder and decoder (i.e., the depersonalization model) to the custom content (step 212). Having been trained to remove personalization, content personalizer 150 may apply the depersonalization model to the custom content to generate a generic version of (i.e., genericize) the custom content. More specifically, and as previously detailed, the depersonalization model may first encode the custom content into a vector space while maintaining semantic equivalence of the input prior to the decoder reconstructing the content in a semantically equivalent but depersonalized style. The resulting genericized text therefore preserves the semantic meaning of the custom content while removing personality.

Continuing the previously introduced example and with reference again to FIG. 3, content personalizer 150 genericizes custom texts 304 to genericized texts 306.

With reference again to FIG. 2, content personalizer 150 may build a parallel corpus pairing the genericized content with the corresponding custom content (step 214). Restated, content personalizer 150 generates a parallel corpus that links the input of the depersonalization model to the output of the depersonalization model. The parallel corpus may link the content at various granularities. For example, in the case of text or speech, the parallel corpus may link the custom and genericized content based on a word, sentence, or paragraph level. Regardless of granularity, however, content personalizer 150 importantly maps the segments of the input to the segments of the output. As will be described in greater detail forthcoming, the resulting parallel corpus provides the data needed for content personalizer 150 to train a personalization model that details a relationship between the custom and genericized content which may then be captured and translated to other content of the same content type.

With reference to the illustrative example depicted by FIG. 3, content personalizer 150 builds a parallel corpus as illustrated by parallel corpus 308 that links genericized texts, y, with corresponding custom text, x, at the sentence level.

Content personalizer 150 may train a personalization model that maps the genericized texts to their corresponding custom texts (step 216). In embodiments, content personalizer 150 generates the paraphrasing model based on analysis of the parallel corpus and via standard model prototyping process, e.g., by tuning a neural encoder-decoder model with a subset of the data and adjusting hyperparameters on a holdout set. The advantage of building the personalization model describing the relationship between custom content and generic content is the capability to apply the personalization model to other content of a same type. For example, a personalization model developed for text may be applied to any text for personalization. Similarly, a personalization model developed for speech may then be applied to any other forms of speech for personalization. Moreover, a personalization model can be generated for different personalities based on the custom content from which the model is built. In other words, training the personalization model with custom content having of a particular personality results in building a personalization model capturing that particular personality. Accordingly, various personalities can be modelled and pre-loaded based on application.

Continuing the previously introduced example and again with reference to FIG. 3, content personalizer 150 creates a personalization model that maps custom texts 304 to genericized text 306 based on parallel corpus 308.

Content personalizer 150 may customize content via application of the personalization model (step 218). Having trained the personalization model to map a relationship between custom content and genericized content, the personalization model may now be applied to incorporate the personality of the custom content into any content of a same content type. For example, the output personalized content may be speech that incorporates a variety of cadence, syntax, and verbiage found within the custom content. Importantly, the framework for developing the personalization model may be applied to any content type so long as it can be mapped to a vector space preserving the appropriate definition of semantic equivalence, thereby enabling ready personalization of text, speech, image data, etc. As such, the proposed system enables users to develop personalization models that may be readily incorporated into existing pipelines. Such pipeline applications may also leverage hierarchical embodiments of this system to personalize data pipelines operating over multiple content types, and may include use within chatbots, commentary (e.g., sports, entertainment), audiobooks, lectures, etc.

In practice, content personalizer 150 may receive user input designating a desired personality or lack thereof with respect to the content they are consuming. Content personalizer 150 may pre-populate one or more pre-set personalities for a user to select from. For example, a user may select highly animated speech commentary for a basketball game that provides more dynamic and variable speed, cadence, volume, and verbiage of the game. In another example, a user may select a calm personality for commentary corresponding to a golf match that provides a moderate amount of variability in speed, cadence, volume, and verbiage. Alternatively, a user may select an analytical personality to effectively depersonalize a course lecture. In embodiments, the pre-set personalities may include well-known figures such as sports announcers and celebrities. In practice, content personalizer 150 may be further configured to determine (or prompt for) which personality or style to associate with users, for example based on user data or feedback. For example, content personalizer 150 may generate a model that associates particular categories of content with desired user preferences and store those preferences in an associated user profile. The model may, for example, determine that a user prefers animated commentary for action sports and automatically select that personality when the user consumes action sports.

Concluding the aforementioned example, content personalizer 150 applies the generated personalization model to generic text output of a chatbot in order to add personality to the outputs. The personality applied to the chatbot outputs make the chatbot feel more personable to the user.

FIG. 3 depicts an exemplary set of texts, in accordance with the exemplary embodiments.

1. A method for personalized content generation, the method comprising:
training, by a system operatively coupled to a processor, a personalization model that maps custom content to genericized custom content based on a parallel corpus linking the custom content to the genericized custom content;
receiving, by the system, electronic content and information indicative of a desired personality from which to personalize the electronic content; and
applying, by the system, the information indicative of the desired personality to the electronic content via application of a personalization model to the electronic content.

2. The method of claim 1, wherein the training the personalization model comprises:
training an encoder to embed generic content into vectors that maintain a semantic meaning of the generic content;
training a decoder to decode the vectors into genericized version of the generic content;
genericizing custom content via application of the encoder and the decoder to custom content;
building the parallel corpus linking the custom content to the genericized custom content; and
training the personalization model that maps the custom content to the genericized custom content based on the parallel corpus.

3. The method of claim 2, wherein the training the decoder comprises minimizing an error between the input custom content and the output genericized custom content.

4. The method of claim 2, wherein the personalization of the content is based on the custom content from which the parallel corpus and the personalization model are built.

5. The method of claim 1, wherein the personalization model, once trained for a content type, personalizes any content of the content type without additional training.

6. The method of claim 1, wherein the personalization model may be versioned for different personalities.

7. The method of claim 1, wherein the content is selected from content types consisting of text, image, audio, and video.

8. A computer program product for personalized content generation, the computer program product comprising:
one or more non-transitory computer-readable storage media and program instructions stored on the one or more non-transitory computer-readable storage media capable of performing a method, the method comprising:
training a personalization model that maps custom content to genericized custom content based on a parallel corpus linking the custom content to the genericized custom content;
receiving electronic content and information indicative of a desired personality from which to personalize the electronic content; and
applying the information indicative of the desired personality to the electronic content via application of a personalization model to the electronic content.

9. The computer program product of claim 8, wherein the personalization model is generated by:
training an encoder to embed generic content into vectors that maintain a semantic meaning of the generic content;
training a decoder to decode the vectors into genericized version of the generic content;
genericizing custom content via application of the encoder and the decoder to custom content;
building a parallel corpus linking the custom content to the genericized custom content; and
training a personalization model that maps the custom content to the genericized custom content based on the parallel corpus.

10. The computer program product of claim 9, wherein the decoder is trained by minimizing an error between the input custom content and the output genericized custom content.

11. The computer program product of claim 9, wherein the personalization of the content is based on the custom content from which the parallel corpus and the personalization model is built.

12. The computer program product of claim 8, wherein the personalization model, once trained for a content type, personalizes any content of the content type without additional training.

13. The computer program product of claim 8, wherein the personalization model may be versioned for different personalities.

14. The computer program product of claim 8, wherein the content is selected from a group of content types consisting of text, image, audio, and video.

15. A computer system for personalized content generation, the system comprising:
one or more computer processors, one or more computer-readable storage media, and program instructions stored on the one or more of the computer-readable storage media for execution by at least one of the one or more processors capable of performing a method, the method comprising:
training a personalization model that maps custom content to genericized custom content based on a parallel corpus linking the custom content to the genericized custom content;
receiving electronic content and information indicative of a desired personality from which to personalize the content; and
applying the information indicative of the desired personality to the electronic content via application of a personalization model to the electronic content.

16. The computer system of claim 15, wherein the training the personalization model comprises:
training an encoder to embed generic content into vectors that maintain a semantic meaning of the generic content;
training a decoder to decode the vectors into genericized version of the generic content;
genericizing custom content via application of the encoder and the decoder to custom content;
building a parallel corpus linking the custom content to the genericized custom content; and
training the personalization model that maps the custom content to the genericized custom content based on the parallel corpus.

17. The computer system of claim 16, wherein the decoder is trained by minimizing an error between the input custom content and the output genericized custom content.

18. The computer system of claim 16, wherein the personalization of the content is based on the custom content from which the parallel corpus and the personalization model is built.

19. The computer system of claim 15, wherein the personalization model, once trained for a content type, personalizes any content of the content type without additional training.

20. The computer system of claim 15, wherein the personalization model may be versioned for different personalities.
